(19) United States
(12) Patent Application Publication
(10) Pub. No.: US 2016/0330099 A1
(43) Pub. Date: Nov. 10, 2016

(54) APPARATUS AND METHOD FOR CONTROLLING DATA RATE IN WIRELESS COMMUNICATION SYSTEM

(71) Applicants: Samsung Electronics Co., Ltd., Gyeonggi-do (KR); Seoul National University R & DB Foundation, Seoul (KR)

(72) Inventors: Ji-Hun KOO, Gyeonggi-do (KR); Chang-Won Nam, Seoul (KR); Sae-Woong Bahk, Seoul (KR)

(73) Assignees: Samsung Electronics Co., Ltd.; Seoul National University R & DB Foundation

(21) Appl. No.: 15/082,596

(22) Filed: Mar. 28, 2016

(30) Foreign Application Priority Data
May 7, 2015 (KR) 10-2015-0063761

(51) Int. Cl. H04L 12/26; H04W 24/02

(52) U.S. Cl. CPC H04L 43/0894; H04L 43/16; H04W 24/02

(57) ABSTRACT

A method of controlling a data rate by a transmitting device in a wireless communication system and the transmitting device are provided. The method includes detecting a condition to change a current data rate; performing a probing process based on a bandwidth and a Modulation and Coding Scheme (MCS); and controlling the data rate based on a result of the probing process. The transmitting device includes a controller configured to detect a condition to change a current data rate; and a transmitter and a receiver configured to perform a probing process based on a bandwidth and an MCS, wherein the controller is further configured to control a data rate based on a result of the probing process.

### PRIORITY

This application claims priority under 35 U.S.C. §119(a) to a Korean Patent Application filed on May 7, 2015 in the Korean Intellectual Property Office and assigned Serial No. 10-2015-0063761, the entire disclosure of which is incorporated herein by reference.

### BACKGROUND

1. Field of the Disclosure

The present disclosure relates generally to an apparatus and method for controlling a data rate in a wireless communication system, and more particularly, to an apparatus and method for controlling a data rate based on a Modulation and Coding Scheme (MCS) and a bandwidth.

2. Description of the Related Art

A wireless communication system defines various data rates in order to adaptively deal with radio channel change. A data rate is determined based on a modulation scheme and a coding rate which are applied to a data bit and a bandwidth of a used channel.

For example, an Institute of Electrical and Electronics Engineers (IEEE) 802.11 system which is based on an IEEE 802.11 standard defines 9 MCS levels as shown in Table 1 as follows. Here, the IEEE 802.11 system may be an IEEE 802.11 ac system which is based on an IEEE 802.11 ac standard.

TABLE 1

| MCS Index | Modulation | Coding Rate |
|---|---|---|
| 0 | BPSK | 1/2 |
| 1 | QPSK | 1/2 |
| 2 | QPSK | 3/4 |
| 3 | 16-QAM | 1/2 |
| 4 | 16-QAM | 3/4 |
| 5 | 64-QAM | 2/3 |
| 6 | 64-QAM | 3/4 |
| 7 | 64-QAM | 5/6 |
| 8 | 256-QAM | 3/4 |
| 9 | 256-QAM | 5/6 |

In Table 1 above, “MCS Index” denotes an index for an MCS level, “Modulation” denotes a modulation scheme which is mapped to a related MCS Index, and “Coding Rate” denotes a coding rate which is mapped to the related MCS Index. For example, in Table 1 above, MCS Index 0 denotes a Binary Phase Shift Keying (BPSK) modulation scheme and a coding rate of 1/2.

In addition, the IEEE 802.11 system defines a channel bandwidth as shown in Table 2 as follows. Here, the IEEE 802.11 system may be an IEEE 802.11 ac system which is based on an IEEE 802.11 ac standard.

TABLE 2

| | Channel Bandwidth | |
|---|---|---|
| Index | (BW) | |
| CBW20 | 20 | MHz |
| CBW40 | 40 | MHz |
| CBW80 | 80 | MHz |
| CBW160 | 160 | MHz |
| CBW80 + 80 | 80 + 80 | MHz |

In Table 2 above, “Index” denotes an index for a channel bandwidth, and “Channel Bandwidth (BW)” denotes a channel bandwidth which is mapped to a related index. For example, in Table 2 above, CBW20 denotes an index for a 20 MHz channel bandwidth.

In the IEEE 802.11 system, a total of 35 data rates are defined based on MCS levels shown in Table 1 above and channel bandwidths shown in Table 2 above.

In a wireless communication system, a data rate adaptation scheme has been proposed, where a data rate adaptation scheme denotes a scheme where a data rate is changed in accordance with a change in a wireless channel environment.

In a data rate adaptation scheme, a data rate is adaptively adjusted on a data packet basis in a single wireless link including a transmitting device and a receiving device. A data rate adaptation scheme is classified into either an open-loop data rate adaptation scheme or a closed-loop data rate adaptation scheme according to whether there is a feedback operation for the receiving device. Each of the open-loop data rate adaptation scheme and the closed-loop data rate adaptation scheme are described below.

A closed-loop data rate adaptation scheme is described below.

In a closed-loop data rate adaptation scheme, upon successfully receiving a data packet, a receiving device feeds channel information or information related to a data rate which will be applied to the next data packet back to a transmitting device. A transmitting device sets a data rate which will be applied to the next data packet based on the information which is fed back from the receiving device.

An open-loop data rate adaptation scheme is described below.

In an open-loop data rate adaptation scheme, a receiving device does not feed information back to a transmitting device unlike in a closed-loop data rate adaptation scheme. Thus, a transmitting device determines a data rate based on whether a data packet is successfully transmitted.

An open-loop data rate adaptation scheme has the following advantages as compared to a closed-loop data rate adaptation scheme.

First, an open-loop data rate adaptation scheme must be implemented only in a transmitting device, so there is no need to modify a receiving device.

In addition, there is no need for a process of feeding back related information and an additional message type.

If an open-loop data rate adaptation scheme is implemented in a transmitting device, e.g., a User Equipment (UE), it is possible to adjust a data rate regardless of an enhanced Node B (eNB) and an Access Point (AP) with which the transmitting device communicates.

Furthermore, most general data rate adaptation schemes adjust a data rate by changing an MCS level while fixing a bandwidth. For example, an Automatic Rate Fallback (ARF) scheme or a sample rate scheme as a typical data rate adaptation scheme for a wireless Local Access Network (LAN) system adjusts a data rate by changing an MCS level without considering bandwidth change. Due to this, in an environment where there are various bandwidth options, it is impossible to adaptively use a bandwidth which is optimal for a related situation. More particularly, if there is relatively strong interference at a certain band, it is preferable to transmit/receive a signal through a band other than the certain band. However, in data rate adaptation schemes such as the ARF scheme and the sample rate scheme, it is impossible to avoid such interference since the data rate adaptation schemes do not consider bandwidth change.

Alternatively, there are data rate adaptation schemes that consider a bandwidth and an MCS level at the same time, and a typical one is an Agile Rate Adaptation for MIMO Systems (ARAMIS) scheme.

The ARAMIS scheme uses a closed-loop scheme where a receiving device determines a data rate, and feeds back information related to the determined data rate to a transmitting device. Thus, to use the ARAMIS scheme, it must be implemented in both a transmitting device and a receiving device, and there is a need for a process and a message type for feeding back information related to a data rate. Even though an ARAMIS scheme is implemented in a receiving device, e.g., a UE, adjustment of a data rate is impossible if a transmitting device, e.g., an eNB and an access point do not support the ARAMIS scheme.

As described above, data rate adaptation schemes which have been proposed do not consider a bandwidth along with an MCS or operate in a closed-loop form.

Thus, there is a need for a scheme for controlling a data rate in a wireless communication system.

### SUMMARY

An aspect of the present disclosure provides an apparatus and method for controlling a data rate based on a bandwidth and an MCS in a wireless communication system.

Another aspect of the present disclosure provides an apparatus and method for controlling a data rate in an open-loop form in a wireless communication system.

Another aspect of the present disclosure provides an apparatus and method for controlling a data rate based on a bandwidth and an MCS by a data packet basis in a wireless communication system.

Another aspect of the present disclosure provides an apparatus and method for controlling a data rate thereby increasing communication throughput in a wireless communication system.

Another aspect of the present disclosure provides an apparatus and method for adaptively controlling a data rate based on channel status in a wireless communication system.

Another aspect of the present disclosure provides an apparatus and method for controlling a data rate thereby preventing interference in a wireless communication system.

In accordance with an aspect of the present disclosure, a method of controlling a data rate by a transmitting device in a wireless communication system is provided. The method includes detecting a condition to change a current data rate; performing a probing process based on a bandwidth and an MCS; and controlling the data rate based on a result of the probing process.

In accordance with an aspect of the present disclosure, a transmitting device in a wireless communication system is provided. The transmitting device includes a controller configured to detect a condition to change a current data rate; and a transmitter and a receiver configured to perform a probing process based on a bandwidth and an MCS, wherein the controller is further configured to control a data rate based on a result of the probing process.

### BRIEF DESCRIPTION OF THE DRAWINGS

The above and other aspects, features and advantages of the present disclosure will be more apparent from the following description, taken in conjunction with the accompanying drawings, in which:

FIG. 1 schematically illustrates a process of controlling a data rate based on a probing process in a wireless communication system according to an embodiment of the present disclosure;

FIG. 2 is a flowchart of a method of performing a probing process in a transmitting device in a wireless communication system according to an embodiment of the present disclosure;

FIG. 3 is a flowchart of a method of performing a probing process corresponding to a bandwidth increase timer in a wireless communication system according to an embodiment of the present disclosure;

FIG. 4 is a flowchart of a method of performing a probing process corresponding to a bandwidth decrease timer in a wireless communication system according to an embodiment of the present disclosure;

FIG. 5 is a flowchart of a method of performing a probing process corresponding to an MCS level increase timer in a wireless communication system according to an embodiment of the present disclosure;

FIG. 6 is a flowchart of a method of performing a probing process corresponding to an MCS level decrease timer in a wireless communication system according to an embodiment of the present disclosure;

FIGS. 7A and 7B are flowcharts of a method of performing a probing process corresponding to a bandwidth increase timer and an MCS level increase timer in a wireless communication system according to an embodiment of the present disclosure;

FIGS. 8A and 8B are flowcharts of a method of performing a probing process corresponding to a bandwidth decrease timer and an MCS level decrease timer in a wireless communication system according to an embodiment of the present disclosure;

FIG. 9 is a graph illustrating performance according to data rate control in a non-interference environment in a wireless communication system according to an embodiment of the present disclosure;

FIG. 10 is a graph illustrating performance according to data rate control in an interference environment in a wireless communication system according to an embodiment of the present disclosure;

FIG. 11 is a block diagram of a transmitting device in a wireless communication system according to an embodiment of the present disclosure; and

FIG. 12 is a block diagram of a receiving device in a wireless communication system according to an embodiment of the present disclosure.

### DETAILED DESCRIPTION OF EMBODIMENTS OF THE PRESENT DISCLOSURE

The following description with reference to the accompanying drawings is provided to assist in a comprehensive understanding of various embodiments of the present disclosure as defined by the appended claims and their equivalents. It includes certain details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness. Throughout the accompanying drawings, like reference numbers are used to depict the same or similar elements, features, and structures.

The words used in the following description and claims are not limited to their dictionary meanings, but, are merely used to enable a clear and consistent understanding of the present disclosure. Accordingly, it should be apparent to those skilled in the art that the following description of various embodiments of the present disclosure is provided for illustration purposes only and not for the purpose of limiting the present disclosure as defined by the appended claims and their equivalents.

It is to be understood that the singular forms “a,” “an,” and “the” include plural referents unless the context clearly dictates otherwise. Thus, for example, a reference to “a component surface” includes a reference to one or more of such surfaces.

Although ordinal numbers such as “first,” “second,” and so forth will be used to describe various components, those components are not limited herein. The terms are used only for distinguishing one component from another component. For example, a first component may be referred to as a second component and likewise, a second component may also be referred to as a first component, without departing from the scope and spirit of the present disclosure. The term “and/or” used herein includes any and all combinations of one or more of the associated listed items.

The terminology used herein is for the purpose of describing various embodiments only and is not intended to be limiting. As used herein, the singular forms are intended to include the plural forms as well, unless the context clearly indicates otherwise. It will be further understood that the terms “comprises” and/or “has,” when used in the present disclosure, indicate the presence of a stated feature, number, step, operation, component, element, or combination thereof, but do not preclude the presence or addition of one or more other features, numbers, steps, operations, components, elements, or combinations thereof.

The terms used herein have the same meanings as terms that are generally understood by those skilled in the art, as long as the terms are not differently defined. It should be understood that terms defined in a generally-used dictionary have meanings coinciding with those of terms in the related technology.

According to various embodiments of the present disclosure, an electronic device may include communication functionality. For example, an electronic device may be a smart phone, a tablet Personal Computer (PC), a mobile phone, a video phone, an e-book reader, a desktop PC, a laptop PC, a netbook PC, a Personal Digital Assistant (PDA), a Portable Multimedia Player (PMP), an Moving Picture Experts Group Audio layer 3 (MP3) player, a mobile medical device, a camera, a wearable device (e.g., a Head-Mounted Device (HMD), electronic clothes, electronic braces, an electronic necklace, an electronic appcessory, an electronic tattoo, or a smart watch), and/or the like.

According to various embodiments of the present disclosure, an electronic device may be a smart home appliance with communication functionality. A smart home appliance may be, for example, a television, a digital video disk (DVD) player, an audio, a refrigerator, an air conditioner, a vacuum cleaner, an oven, a microwave oven, a washer, a dryer, an air purifier, a set-top box, a TV box (e.g., Samsung HomeSync™, Apple TV®, or Google TV™), a gaming console, an electronic dictionary, an electronic key, a camcorder, an electronic picture frame, and/or the like.

According to various embodiments of the present disclosure, an electronic device may be a medical device (e.g., Magnetic Resonance Angiography (MRA) device, a Magnetic Resonance Imaging (MRI) device, Computed Tomography (CT) device, an imaging device, or an ultrasonic device), a navigation device, a Global Positioning System (GPS) receiver, an Event Data Recorder (EDR), a Flight Data Recorder (FDR), an automotive infotainment device, a naval electronic device (e.g., naval navigation device, gyroscope, or compass), an avionic electronic device, a security device, an industrial or consumer robot, and/or the like.

According to various embodiments of the present disclosure, an electronic device may be furniture, part of a building/structure, an electronic board, electronic signature receiving device, a projector, various measuring devices (e.g., water, electricity, gas or electro-magnetic wave measuring devices), and/or the like that include communication functionality.

According to various embodiments of the present disclosure, an electronic device may be any combination of the foregoing devices. In addition, it will be apparent to one having ordinary skill in the art that an electronic device according to various embodiments of the present disclosure is not limited to the foregoing devices.

According to various embodiments of the present disclosure, for example, a receiving device may be an electronic device.

According to various embodiments of the present disclosure, for example, a receiving device may be a UE.

According to various embodiments of the present disclosure, for example, a transmitting device may be an eNB or an AP.

An embodiment of the present disclosure provides an apparatus and method for controlling a data rate based on a bandwidth and an MCS in a wireless communication system.

An embodiment of the present disclosure provides an apparatus and method for controlling a data rate in an open-loop form in a wireless communication system.

An embodiment of the present disclosure provides an apparatus and method for controlling a data rate based on a bandwidth and an MCS by a data packet basis in a wireless communication system.

An embodiment of the present disclosure provides an apparatus and method for controlling a data rate thereby increasing communication throughput in a wireless communication system.

An embodiment of the present disclosure provides an apparatus and method for adaptively controlling a data rate based on channel status in a wireless communication system.

An embodiment of the present disclosure provides an apparatus and method for controlling a data rate thereby preventing interference in a wireless communication system.

In accordance with an aspect of the present disclosure, a method for controlling a data rate by a transmitting device in a wireless communication system is provided. The method includes detecting a need (e.g., a condition) to change a current data rate; performing a probing process based on a bandwidth and an MCS; and controlling a data rate based on a result of the probing process.

In accordance with an aspect of the present disclosure, a transmitting device in a wireless communication system is provided. The transmitting device includes a controller configured to perform an operation of detecting a need to change a current data rate, and a transmitter and a receiver configured to perform an operation of performing a probing process based on a bandwidth and an MCS, wherein the controller performs an operation of controlling a data rate based on a result of the probing process.

Before providing the detailed description below, it may be advantageous to set forth definitions of certain words and phrases used throughout the present disclosure. The terms “include” and “comprise,” as well as derivatives thereof, indicate inclusion without limitation; the term “or,” is inclusive, indicating and/or; the phrases “associated with” and “associated therewith, “as well as derivatives thereof, may indicate to include, be included within, interconnect with, contain, be contained within, connect to or with, couple to or with, be communicable with, cooperate with, interleave, juxtapose, be proximate to, be bound to or with, have, have a property of, or the like; and the term “controller” indicates any device, system or part thereof that controls at least one operation, where such a device may be implemented in hardware, firmware or software, or some combination of at least two of the same. It should be noted that the functionality associated with any particular controller may be centralized or distributed, whether locally or remotely. Definitions for certain words and phrases are provided throughout the present disclosure, where those of ordinary skill in the art should understand that in many, if not most instances, such definitions apply to prior, as well as future uses of such defined words and phrases.

A method and apparatus provided in various embodiments of the present disclosure may be applied to various mobile communication systems such as a Long Term Evolution (LTE) mobile communication system, an LTE-Advanced (LTE-A) mobile communication system, a High Speed Downlink Packet Access (HSDPA) mobile communication system, a High Speed Uplink Packet Access (HSUPA) mobile communication system, a High Rate Packet Data (HRPD) mobile communication system proposed in a 3rd Generation Partnership Project 2 (3GPP2), a Wideband Code Division Multiple Access (WCDMA) mobile communication system proposed in the 3GPP2, a Code Division Multiple Access (CDMA) mobile communication system proposed in the 3GPP2, an IEEE 802.16m communication system, an IEEE 802.11 communication system, an Evolved Packet System (EPS), a Mobile Internet Protocol (Mobile IP) system, a Wireless Universal Serial Bus (Wireless USB) system and/or the like. Further, it will be noted that the IEEE 802.11 communication system may be an IEEE 802.11ac communication system which is based on an IEEE 802.11 ac standard.

A scheme of controlling a data rate provided in an embodiment of the present disclosure is described below.

A data rate may be controlled based on an MCS and a bandwidth. In an embodiment of the present disclosure, a transmitting device uses an MCS level and a bandwidth which are adjacent to a current MCS level and a current bandwidth, respectively, upon changing an MCS level and a bandwidth in order to control a data rate. That is, the transmitting device changes an MCS level to an MCS level increased by a preset level, e.g., 1 level from a current MCS level upon changing the MCS level, and the transmitting device changes a bandwidth to a bandwidth increased by multiplying a current bandwidth by a preset number, e.g., 2, upon changing the bandwidth.

As described above, a transmitting device changes an MCS level to an MCS level increased by a preset number from a current MCS level, and changes a bandwidth to a bandwidth increased by multiplying a current bandwidth by a preset number. However, it will be understood by those of ordinary skill in the art that the transmitting device changes the MCS level to an MCS level decreased by a preset number from the current MCS level, and changes the bandwidth to a bandwidth decreased by multiplying the current bandwidth by a preset number.

In this case, a data rate control scheme provided in an embodiment of the present disclosure may be classified into the following two schemes according to whether to change a bandwidth in order to control a data rate.

A data rate control scheme is based on an MCS level control scheme.

If the data rate control scheme which is based on the MCS level control scheme is used, a transmitting device maintains a current bandwidth and changes an MCS level to control a data rate.

Upon detecting a need to increase a data rate, the transmitting device increases an MCS level by a preset number, e.g., 1 from a current MCS level to increase the data rate. Alternatively, upon detecting a need to decrease a data rate, the transmitting device decreases an MCS level by a preset number, e.g., 1 from a current MCS level to decrease the data rate.

A data rate control scheme is based on a bandwidth control scheme.

If the data control scheme which is based on the bandwidth control scheme is used, a transmitting device controls a data rate by changing a bandwidth or by changing a bandwidth and an MCS level at the same time.

Upon detecting a need to increase a data rate, the transmitting device increases a data rate by changing a bandwidth to a bandwidth increased by multiplying a current bandwidth by a preset number, e.g., 2, or by changing a bandwidth to a bandwidth increased by multiplying a current bandwidth by a preset number, e.g., 2 and changing an MCS level to an MCS level decreased by a preset number, e.g., 1 from a current MCS level. In contrast, upon detecting a need to decrease a data rate, the transmitting device decreases a data rate by changing a bandwidth to a bandwidth decreased by multiplying a current bandwidth by a preset number, e.g., 1/2, or by changing a bandwidth to a bandwidth decreased by multiplying a current bandwidth by a preset number, e.g., 1/2 and changing an MCS level to an MCS level decreased by a preset number, e.g., 1 from a current MCS level.

An operation of increasing a data rate in a transmitting device will be described with reference to Table 3.

TABLE 3

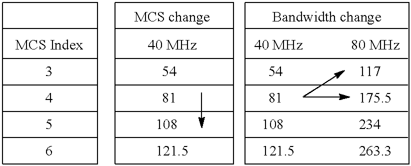

In Table 3 above, an MCS Index denotes an index of an MCS level.

Table 3 above describes MCS level and bandwidth control if the transmitting device increases a data rate in a case where a current data rate is 81 Mbps (MCS=4, BW=40 MHz).

Upon using a data rate control scheme which is based on an MCS level control scheme, the transmitting device increases a data rate to 108 Mbps by maintaining a current bandwidth 40 MHz and increasing an MCS level from an MCS level 4 as a current MCS level to an MCS level 5.

Alternatively, upon using a data rate control scheme which is based on a bandwidth control scheme, the transmitting device increases a data rate by increasing a bandwidth from 40 MHz as a current bandwidth to 80 MHz, which is 2 times 40 MHz, and maintaining MCS level 4 as a current MCS level or decreasing an MCS level from the MCS level 4 to MCS level 3 which is decreased by 1 from the MCS level 4.

A data rate control scheme provided in an embodiment of the present disclosure is described above, and a probing process for data rate control provided in an embodiment of the present disclosure is described below.

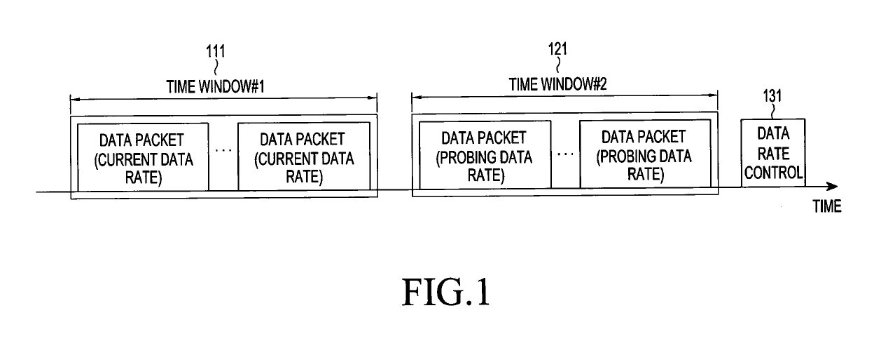

A process of controlling a data rate based on a probing process in a wireless communication system according to an embodiment of the present disclosure is described with reference to FIG. 1.

FIG. 1 schematically illustrates a process of controlling a data rate based on a probing process in a wireless communication system according to an embodiment of the present disclosure.

Referring to FIG. 1, terms used in a process of controlling a data rate based on a probing process in a wireless communication system according to an embodiment of the present disclosure are described below.

(1) Current data rate

A current data rate denotes a data rate which a transmitting device currently uses.

(2) Current throughput

A current throughput denotes throughput which is currently measured.

(3) Probing data rate

A probing data rate denotes a data rate which is used in a case where a transmitting device performs a probing process.

(4) Probing throughput

A probing throughput denotes throughput which is measured while a transmitting device performs a probing process.

(5) Time window

A time window denotes time for calculating throughout. A plurality of packets are transmitted in a time window, and a transmitting device may measure throughput by detecting the number of data packets which are successfully received among the data packets which are transmitted in the time window.

As described above with reference to FIG. 1, a transmitting device performs a probing process while transmitting data packets at a current data rate in a time window#1 111 to transmit data packets at a probing data rate in a time window#2 121. Data packets which are transmitted during the probing process may be general data packets not specific packets for the probing process. Alternatively, the data packets which are transmitted during the probing process may be specific packets for the probing process. In an embodiment of the present disclosure, it is assumed that the general data packets not the specific packets are typically used for the probing process.

The transmitting device controls a data rate based on a result of the probing process at operation 131. The transmitting device may calculate probing throughput by detecting the number of data packets which are successfully received among the data packets which are transmitted during the time window#2 121. The transmitting device controls a data rate based on the calculated probing throughput. For example, the transmitting device may change a data rate if the calculated probing throughput is greater than the current throughput.

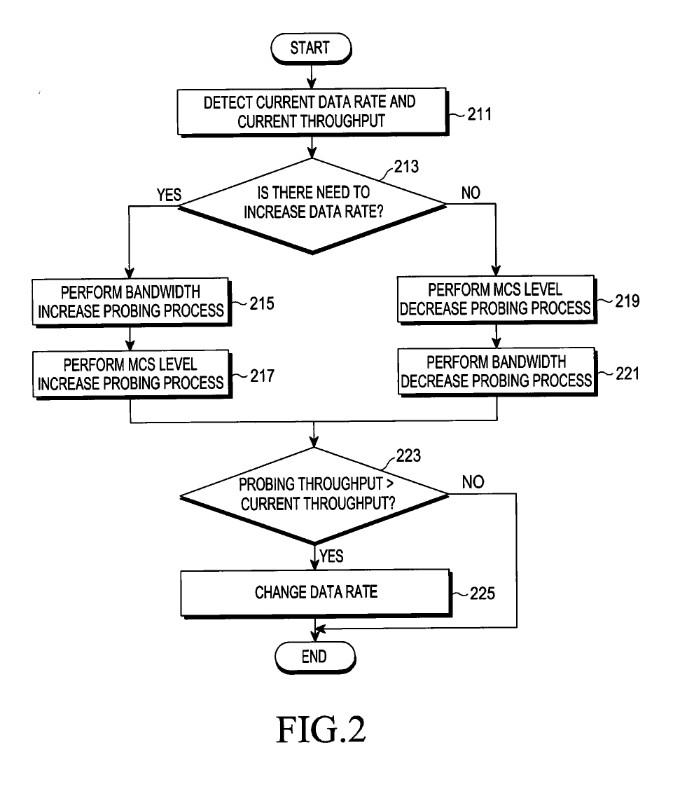

A process of controlling a data rate based on a probing process in a wireless communication system according to an embodiment of the present disclosure is described above with reference to FIG. 1, and a process of performing a probing process in a transmitting device in a wireless communication system according to an embodiment of the present disclosure is described below with reference to FIG. 2.

FIG. 2 is a flowchart of a method of performing a probing process in a transmitting device in a wireless communication system according to an embodiment of the present disclosure.

Referring to FIG. 2, the transmitting device detects a current data rate and a current throughput in step 211. The transmitting device determines whether there is a need to increase a data rate in step 213. If there is a need to increase the data rate, the transmitting device performs a bandwidth increase probing process in step 215. The transmitting device performs an MCS level increase probing process in step 217.

If there is no need to increase the data rate, that is, there is a need to maintain the data rate or decrease the data rate, the transmitting device performs an MCS level decrease probing process in step 219. The transmitting device performs a bandwidth decrease probing process in step 221.

The transmitting device determines whether probing throughput is greater than the current throughput in step 223. If the probing throughput is greater than the current throughput, the transmitting device changes a data rate in step 225.

In FIG. 2, the transmitting device controls a data rate according to whether there is the need to increase the data rate like step 213, however, it will be understood by those of ordinary skill in the art that the transmitting device controls the data rate according to whether there is a need to change the data rate. An operation of determining whether there is the need to change the data rate may be performed based on various timers, the various timers are described below, and a detailed description thereof will be omitted herein.

Although FIG. 2 illustrates a method of performing a probing process in a transmitting device in a wireless communication system according to an embodiment of the present disclosure, various changes could be made to FIG. 2. For example, although shown as a series of operations, various operations in FIG. 2 could overlap, occur in parallel, occur in a different order, or occur multiple times.

A probing process is performed during preset time using a timer. In an embodiment of the present disclosure, four timers as described in Table 4, i.e., a bandwidth increase timer, a bandwidth decrease timer, an MCS level increase timer, and an MCS level decrease timer are defined as follows.

TABLE 4

| Name | Operation |
|---|---|
| bandwidth increase timer | perform bandwidth increase probing process |
| bandwidth decrease timer | perform bandwidth decrease probing process |
| MCS level increase timer | perform MCS level increase probing process |
| MCS level decrease timer | perform MCS level decrease probing process |

Each of timers in Table 4 above independently operates, and expires if a preset time lapses. If there is a timer which has expired among the four timers, the transmitting device performs an operation which corresponds to the expired timer. For example, if the bandwidth increase timer expires, the transmitting device determines a data rate which is determined by increasing a bandwidth as a probing data rate, and performs a probing process corresponding to the probing data rate.

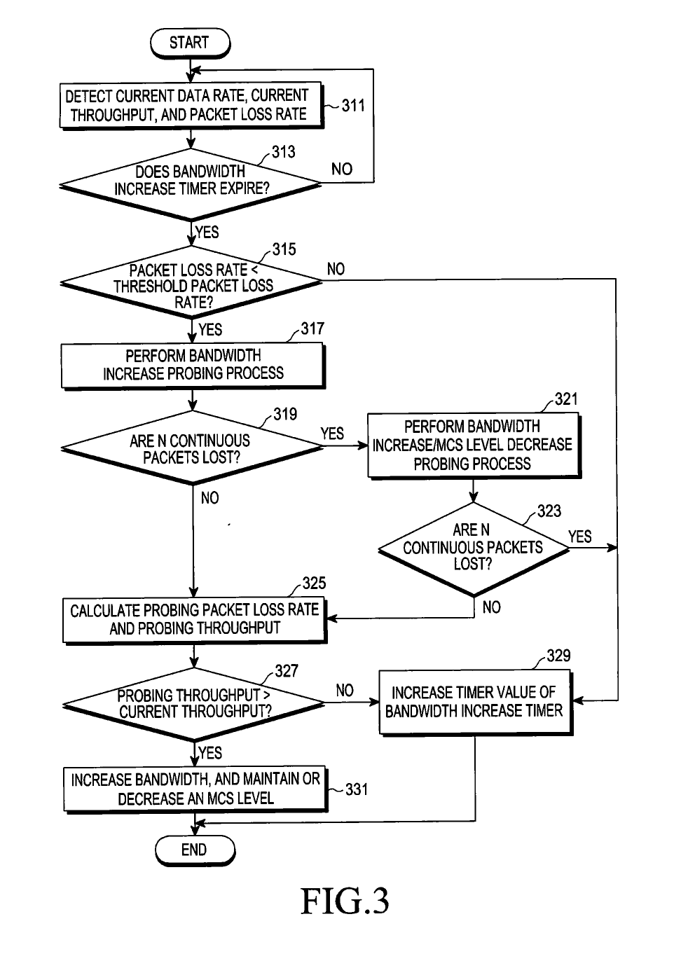

A probing process which is performed in a case where each of the bandwidth increase timer, the bandwidth decrease timer, the MCS level increase timer, and the MCS level decrease timer expires is similar to a probing process as described above with reference to FIG. 2, and probing processes corresponding to the bandwidth increase timer, the bandwidth decrease timer, the MCS level increase timer, and the MCS level decrease timer are described below with reference to FIGS. 3 to 6.

A process of performing a probing process corresponding to a bandwidth increase timer in a wireless communication system according to an embodiment of the present disclosure is described below with reference to FIG. 3.

FIG. 3 is a flowchart of a method of performing a probing process corresponding to a bandwidth increase timer in a wireless communication system according to an embodiment of the present disclosure.

Referring to FIG. 3, a transmitting device detects a current data rate, a current throughput, and a packet loss rate in step 311. The transmitting device determines whether a bandwidth increase timer expires in step 313. If the bandwidth increase timer does not expire, the transmitting device returns to step 311.

If the bandwidth increase timer expires, the transmitting device determines whether a packet loss rate is less than a preset threshold packet loss rate in step 315. The reason why the transmitting device determines whether the packet loss rate is less than the threshold packet loss rate is to prevent performing unnecessary a bandwidth increase probing process even though channel status is bad. If the packet loss rate is not less than the threshold packet loss rate, that is, if the packet loss rate is greater than or equal to the threshold packet loss rate, the transmitting device proceeds to step 329.

If the packet loss rate is less than the threshold packet loss rate, the transmitting device performs a bandwidth increase probing process in step 317. The bandwidth increase probing process denotes a probing process of changing a data rate to a data rate which is acquired by increasing a bandwidth from a current bandwidth to a bandwidth which is acquired by multiplying the current bandwidth by a preset number, e.g., 2, setting the changed data rate as a probing data rate, and transmitting data packets at the probing data rate during a time window. The transmitting device determines whether N continuous packets are lost after performing the bandwidth increase probing process in step 319. For example, N may be 3. If the N continuous packets are lost, the transmitting device performs a bandwidth increase/MCS level decrease probing process in step 321. The bandwidth increase/MCS level decrease probing process denotes a probing process of decreasing a data rate to a data rate which is acquired by changing a bandwidth to a bandwidth by multiplying a current bandwidth by a preset number and changing an MCS level to an MCS level decreased by a preset number from a current MCS level, setting the decreased data rate as a probing data rate, and transmitting data packets at the probing data rate during a time window. Unlike an example of FIG. 3, the bandwidth increase/MCS level decrease probing process may be a probing process of performing at least one of the bandwidth increase probing process and the MCS level decrease probing process.

The transmitting device determines whether N continuous packets are lost after performing the bandwidth increase probing process in step 323. If the N continuous packets are not lost, the transmitting device calculates a probing packet loss rate and probing throughput in step 325. The transmitting device calculates the probing packet loss rate and the probing throughput using Equation (1) and Equation (2) below, respectively.

a probing packet loss rate=the number of packets which are successfully received during a time window/the number of packets which are transmitted during the time window Equation (1)

probing throughput=(the number of packets which are successfully received during a time window*a packet size)/a time window size Equation (2)

The transmitting device determines whether the probing throughout is greater than the current throughout in step 327. If the probing throughout is not greater than the current throughout, that is, the probing throughout is less than or equal to the current throughout, the transmitting device determines to maintain the current data rate, and increases a timer value of the bandwidth increase timer in step 329. The transmitting device increases the timer value of the bandwidth increase timer using Equation (3) as follows.

a timer value of a bandwidth increase timer=Max(2×a timer value of a bandwidth increase timer, a maximum timer value)×Max(1, a probing packet loss rate/0.1) Equation (3)

In Equation (3) above, Max ( ) denotes a function of selecting a maximum value among related parameters.

If the probing throughput is greater than the current throughput, the transmitting device changes a data rate to a probing data rate, and initializes timer values of all of the timers to a minimum value in step 331. That is, the transmitting device increases a bandwidth to a bandwidth multiplied by 2 from a current bandwidth, and maintains a current MCS level or decreases an MCS level to an MCS level decreased by 1 from a current MCS level in step 331.

Although FIG. 3 illustrates a method of performing a probing process corresponding to a bandwidth increase timer in a wireless communication system according to an embodiment of the present disclosure, various changes could be made to FIG. 3. For example, although shown as a series of steps, various steps in FIG. 3 could overlap, occur in parallel, occur in a different order, or occur multiple times.

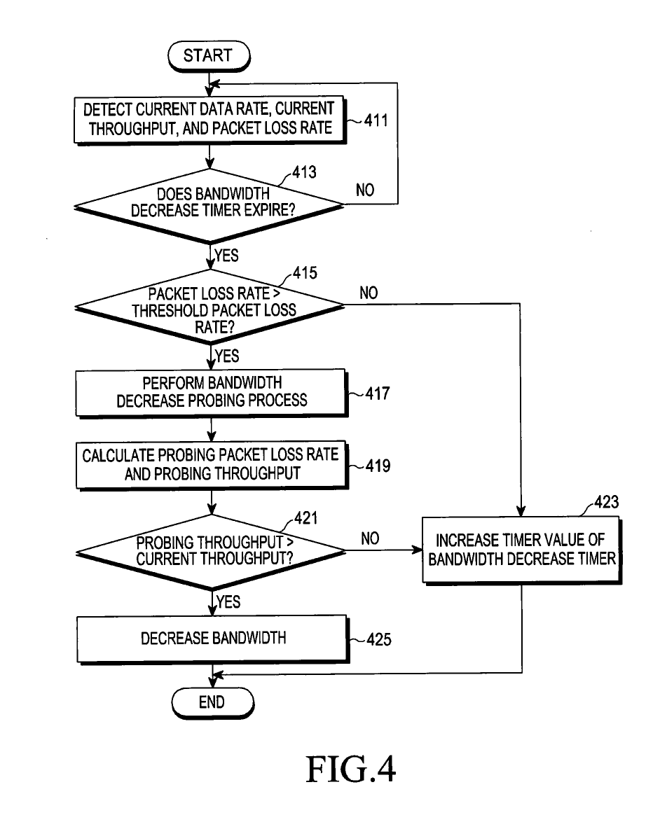

A process of performing a probing process corresponding to a bandwidth increase timer in a wireless communication system according to an embodiment of the present disclosure is described above with reference to FIG. 3, and a process of performing a probing process corresponding to a bandwidth decrease timer in a wireless communication system according to an embodiment of the present disclosure is described below with reference to FIG. 4.

FIG. 4 is a flowchart of a method of performing a probing process corresponding to a bandwidth decrease timer in a wireless communication system according to an embodiment of the present disclosure.

Referring to FIG. 4, a transmitting device detects a current data rate, a current throughput, and a packet loss rate in step 411. The transmitting device determines whether a bandwidth decrease timer expires in step 413. If the bandwidth decrease timer does not expire, the transmitting device returns to step 411.

If the bandwidth decrease timer expires, the transmitting device determines whether the packet loss rate is greater than a preset threshold packet loss rate in step 415. The reason why the transmitting device determines whether the packet loss rate is greater than the threshold packet loss rate is to prevent performing unnecessary bandwidth decrease probing process even though channel status is good. If the packet loss rate is not greater than the threshold packet loss rate, that is, if the packet loss rate is less than or equal to the threshold packet loss rate, the transmitting device proceeds to step 423.

If the packet loss rate is greater than the threshold packet loss rate, the transmitting device performs a bandwidth decrease probing process in step 417. The bandwidth decrease probing process denotes a probing process of changing a data rate to a data rate which is acquired by decreasing a bandwidth from a current bandwidth to a bandwidth which is acquired by multiplying the current bandwidth by a preset number, e.g., 1/2, setting the changed data rate as a probing data rate, and transmitting data packets at the probing data rate during a time window.

The transmitting device calculates a probing packet loss rate and probing throughput in step 419. The transmitting device calculates the probing packet loss rate and the probing throughput using Equation (4) and Equation (5), respectively, as follows.

a probing packet loss rate=the number of packets which are successfully received during a time window/the number of packets which are transmitted during the time window Equation (4)

probing throughput=(the number of packets which are successfully received during a time window*a packet size)/a time window size Equation (5)

The transmitting device determines whether the probing throughout is greater than the current throughout in step 421. If the probing throughout is not greater than the current throughout, that is, the probing throughout is less than or equal to the current throughout, the transmitting device determines to maintain the current data rate, and increases a timer value of the bandwidth decrease timer in step 423. The transmitting device increases the timer value of the bandwidth decrease timer using Equation (6) as follows.

a timer value of a bandwidth decrease timer=Max(2×a timer value of a bandwidth decrease timer, a maximum timer value)×Max(1, a probing packet loss rate/0.1) Equation (6)

If the probing throughput is greater than the current throughput in step 421, the transmitting device changes a data rate to a probing data rate, and initializes timer values of all of the timers to a minimum value in step 425. That is, the transmitting device decreases a bandwidth to a bandwidth multiplied by 1/2 from a current bandwidth in step 425.

Although FIG. 4 illustrates a process of performing a probing process corresponding to a bandwidth decrease timer in a wireless communication system according to an embodiment of the present disclosure, various changes could be made to FIG. 4. For example, although shown as a series of steps, various steps in FIG. 4 could overlap, occur in parallel, occur in a different order, or occur multiple times.

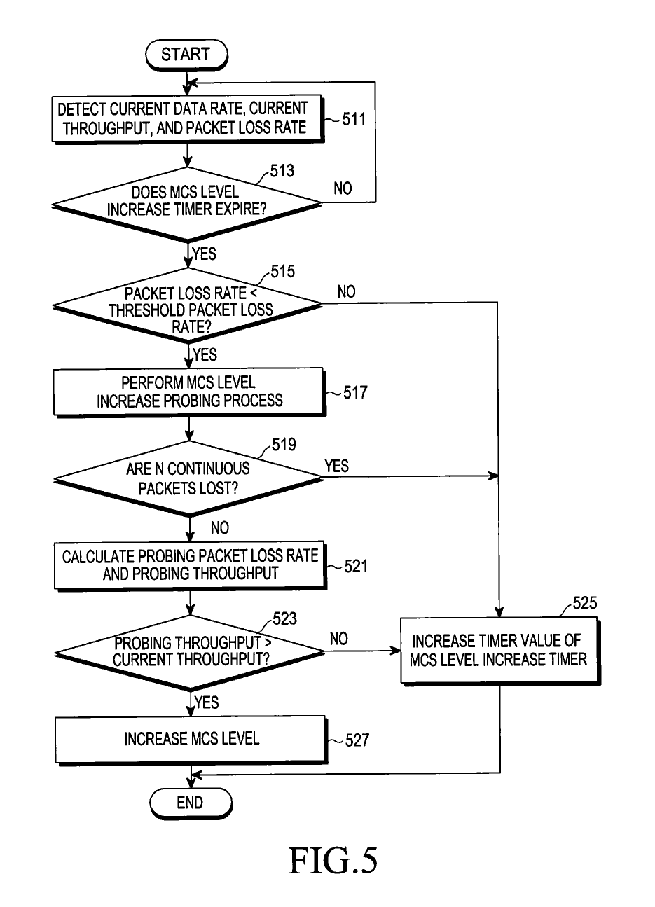

A process of performing a probing process corresponding to a bandwidth decrease timer in a wireless communication system according to an embodiment of the present disclosure is described above with reference to FIG. 4, and a process of performing a probing process corresponding to an MCS level increase timer in a wireless communication system according to an embodiment of the present disclosure is described below with reference to FIG. 5.

FIG. 5 is a flowchart of a method of performing a probing process corresponding to an MCS level increase timer in a wireless communication system according to an embodiment of the present disclosure.

Referring to FIG. 5, a transmitting device detects a current data rate, A current throughput, and a packet loss rate in step 511. The transmitting device determines whether an MCS level increase timer expires in step 513. If the MCS level increase timer does not expire, the transmitting device returns to step 511.

If the MCS level increase timer expires, the transmitting device determines whether the packet loss rate is less than a preset threshold packet loss rate in step 513. The transmitting device determines whether the packet loss rate is less than the threshold packet loss rate to prevent performing unnecessary MCS level increase probing process even though channel status is bad.

If the packet loss rate is less than the threshold packet loss rate, the transmitting device performs an MCS level increase probing process in step 517. The MCS level increase probing process denotes a probing process of changing a data rate to a data rate which is acquired by increasing a current MCS level by a preset number, e.g., 1, setting the changed data rate as a probing data rate, and transmitting data packets at the probing data rate during a time window.

The transmitting device determines whether N continuous packets are lost after performing the MCS level increase probing process in step 519. For example, N may be 3. If the N continuous packets are not lost, the transmitting device calculates a probing packet loss rate and probing throughput in step 521. The transmitting device calculates the probing packet loss rate and the probing throughput using Equation (7) and Equation (8), respectively, as follows.

a probing packet loss rate=the number of packets which are successfully received during a time window/the number of packets which are transmitted during the time window Equation (7)

probing throughput=(the number of packets which are successfully received during a time window*a packet size)/a time window size Equation (8)

The transmitting device determines whether the probing throughout is greater than current throughout in step 523. If the probing throughout is greater than the current throughout, the transmitting device changes a data rate to a probing data rate, and initializes timer values of all timers to a minimum value in step 527. That is, the transmitting device increases an MCS level by 1 from a current MCS level in step 527.

If the packet loss rate is not less than the threshold packet loss rate, that is, the packet loss rate is greater than or equal to the threshold packet loss rate in step 515, if the N continuous packets are lost during the time window in step 519, or if the probing throughput is not greater than the current throughput, that is, the probing throughput is equal to or less than the current throughput in step 523, the transmitting device determines to maintain the current data rate, and increases a timer value of the MCS level increase timer in step 525. The transmitting device increases the timer value of the MCS level increase timer using Equation (9) as follows.

a timer value of an MCS level increase timer=Max(2×a timer value of an MCS level increase timer, a maximum timer value)×Max(1, a probing packet loss rate/0.1) Equation (9)

Although FIG. 5 illustrates a process of performing a probing process corresponding to an MCS level increase timer in a wireless communication system according to an embodiment of the present disclosure, various changes could be made to FIG. 5. For example, although shown as a series of steps, various steps in FIG. 5 could overlap, occur in parallel, occur in a different order, or occur multiple times.

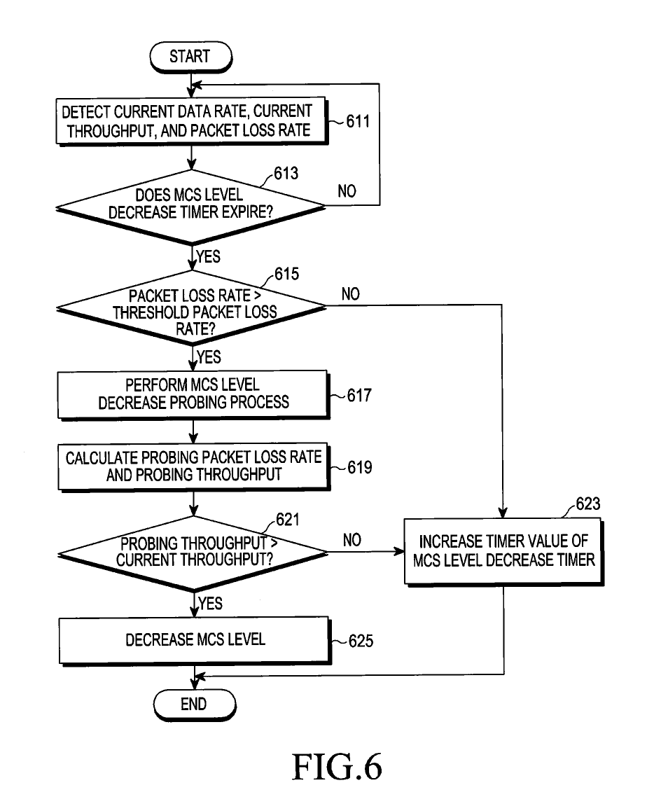

A process of performing a probing process corresponding to an MCS level increase timer in a wireless communication system according to an embodiment of the present disclosure is described above with reference to FIG. 5, and a process of performing a probing process corresponding to an MCS level decrease timer in a wireless communication system according to an embodiment of the present disclosure is described below with reference to FIG. 6.

FIG. 6 is a flowchart of a method of performing a probing process corresponding to an MCS level decrease timer in a wireless communication system according to an embodiment of the present disclosure.

Referring to FIG. 6, a transmitting device detects a current data rate, a current throughput, and a packet loss rate in step 611. The transmitting device determines whether an MCS level decrease timer expires in step 613. If the MCS level decrease timer does not expire, the transmitting device returns to step 611.

If the MCS level decrease timer expires, the transmitting device determines whether the packet loss rate is greater than a preset threshold packet loss rate in step 615. The reason why the transmitting device determines whether the packet loss rate is greater than the threshold packet loss rate is to prevent performing unnecessary MCS level decrease probing process even though channel status is good. If the packet loss rate is not greater than the threshold packet loss rate, that is, if the packet loss rate is less than or equal to the threshold packet loss rate, the transmitting device proceeds to step 623.

If the packet loss rate is greater than the threshold packet loss rate, the transmitting device performs an MCS level decrease probing process in step 617. The MCS level decrease probing process denotes a probing process of changing a data rate to a data rate which is acquired by decreasing a current MCS level by a preset number, e.g., 1, setting the changed data rate as a probing data rate, and transmitting data packets at the probing data rate during a time window.

The transmitting device calculates a probing packet loss rate and probing throughput in step 619. The transmitting device calculates the probing packet loss rate and the probing throughput using Equation (10) and Equation (11), respectively, as follows.

a probing packet loss rate=the number of packets which are successfully received during a time window/the number of packets which are transmitted during the time window Equation (10)

probing throughput=(the number of packets which are successfully received during a time window*a packet size)/a time window size Equation (11)

The transmitting device determines whether the probing throughput is greater than the current throughput in step 621. If the probing throughput is not greater than the current throughput, that is, the probing throughput is less than or equal to the current throughput, the transmitting device determines to maintain the current data rate, and increases a timer value of the MCS level decrease timer in step 623. The transmitting device increases the timer value of the MCS level decrease timer using Equation (12) as follows.

a timer value of an MCS level decrease timer=Max(2×a timer value of an MCS level decrease timer, a maximum timer value)×Max(1, a probing packet loss rate/0.1) Equation (12)

If the probing throughput is greater than the current throughput in step 621, the transmitting device changes a data rate to a probing data rate, and initializes timer values of all timers to a minimum value in step 625. That is, the transmitting device decreases an MCS level by 1 from a current MCS level in step 625.

Although FIG. 6 illustrates a process of performing a probing process corresponding to an MCS level decrease timer in a wireless communication system according to an embodiment of the present disclosure, various changes could be made to FIG. 6. For example, although shown as a series of steps, various steps in FIG. 6 could overlap, occur in parallel, occur in a different order, or occur multiple times.

In a wireless communication system according to an embodiment of the present disclosure, a bandwidth increase timer, a bandwidth decrease timer, an MCS level increase timer, and an MCS level decrease timer independently operate, so at least two of the bandwidth increase timer, the bandwidth decrease timer, the MCS level increase timer, and the MCS level decrease timer may expire at the same time.

In an embodiment of the present disclosure, if the at least two of the bandwidth increase timer, the bandwidth decrease timer, the MCS level increase timer, and the MCS level decrease timer expire, a transmitting device operates based on the following priority.

If the bandwidth increase timer and the bandwidth decrease timer expire at the same time, the transmitting device performs a bandwidth increase probing process and does not perform a bandwidth decrease probing process.

If the bandwidth increase timer and the MCS level decrease timer expire at the same time, the transmitting device performs a bandwidth increase probing process and does not perform an MCS level decrease probing process.

If the MCS level increase timer and the bandwidth decrease timer expire at the same time, the transmitting device performs an MCS level increase probing process and does not perform a bandwidth decrease probing process.

If the MCS level increase timer and the MCS level decrease timer expire at the same time, the transmitting device performs an MCS level increase probing process and does not perform an MCS level decrease probing process.

If the bandwidth increase timer and the MCS level increase timer expire at the same time, bandwidth increase guarantees a higher data rate compared to MCS level increase. So, if the bandwidth increase timer and the MCS level increase timer expire at the same time, the transmitting device performs an MCS level increase probing process after performing a bandwidth increase probing process.

If the bandwidth decrease timer and the MCS level decrease timer expire at the same time, MCS level decrease guarantees a higher data rate compared to bandwidth decrease. So, if the bandwidth decrease timer and the MCS level decrease timer expire at the same time, the transmitting device performs a bandwidth decrease probing process after performing an MCS level decrease probing process.

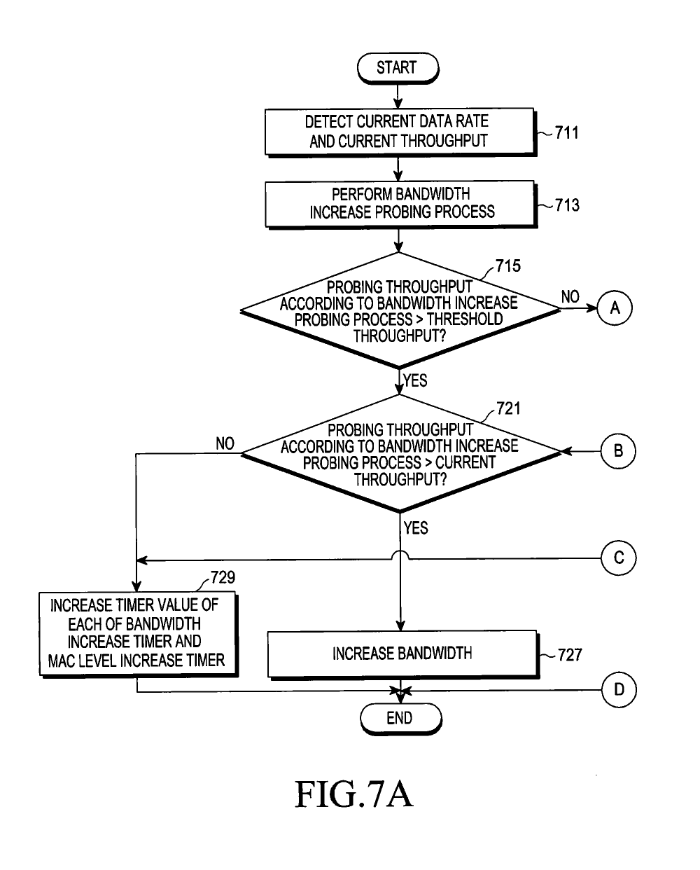

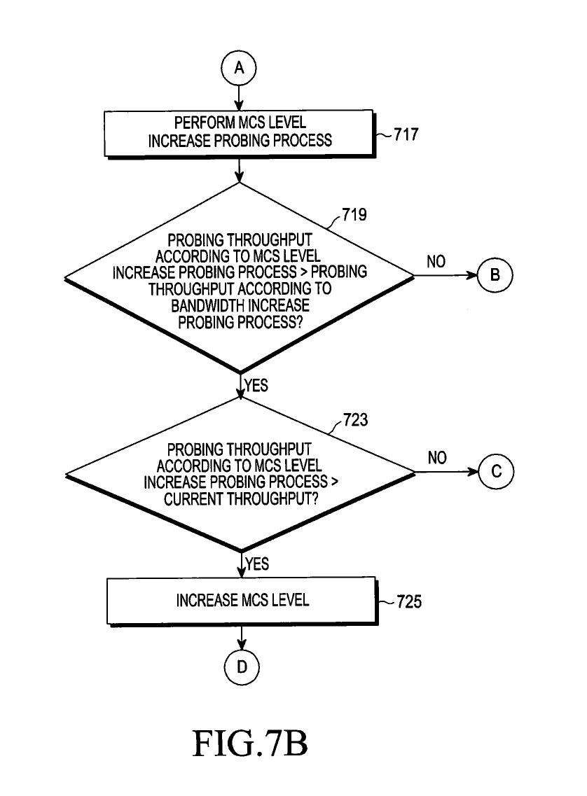

A process of performing a probing process corresponding to a bandwidth increase timer and an MCS level increase timer in a wireless communication system according to an embodiment of the present disclosure is described below with reference to FIGS. 7A and 7B.

FIGS. 7A and 7B are flowcharts of a method of performing a probing process corresponding to a bandwidth increase timer and an MCS level increase timer in a wireless communication system according to an embodiment of the present disclosure.

Referring to FIGS. 7A and 7B, it will be noted that a method of performing a probing process corresponding to a bandwidth increase timer and an MCS level increase timer in FIGS. 7A and 7B is a method of performing a probing process in a case where a bandwidth increase timer and an MCS level increase timer expire at the same time.

A transmitting device detects a current data rate and a current throughput in step 711. The transmitting device performs a bandwidth increase probing process in step 713. The bandwidth increase probing process denotes a probing process of changing a data rate to a data rate which is acquired by increasing a bandwidth from a current bandwidth to a bandwidth which is acquired by multiplying the current bandwidth by a preset number, e.g., 2, setting the changed data rate as a probing data rate, and transmitting data packets at the probing data rate during a time window.

The transmitting device determines whether probing throughput according to a bandwidth increase probing process is greater than a preset threshold throughput in step 715. The reason why the transmitting device determines whether the probing throughput according to the bandwidth increase probing process is greater than the preset threshold throughput is that there is no need to perform an MCS level increase probing process if the probing throughput according to the bandwidth increase probing process is greater than a maximum value of probing throughput according to an MCS level increase probing process. The maximum value of the probing throughput according to the MCS level increase probing process denotes probing throughput according to the MCS level increase probing process in a case where a packet loss rate is 0, that is, a packet error does not occur.

If the probing throughput according to the bandwidth increase probing process is not greater than the threshold throughput, that is, the probing throughput according to the bandwidth increase probing process is less than or equal to the threshold throughput, the transmitting device performs an MCS level increase probing process in step 717. The MCS level increase probing process denotes a probing process of changing a data rate to a data rate which is acquired by increasing a current MCS level by a preset number, e.g., 1, setting the changed data rate as a probing data rate, and transmitting data packets at the probing data rate during a time window.

The transmitting device determines whether the probing throughput according to the MCS level increase probing process is greater than the probing throughput according to the bandwidth increase probing process in step 719. If the probing throughput according to the MCS level increase probing process is greater than the probing throughput according to the bandwidth increase probing process, the transmitting device determines whether the probing throughput according to the MCS level increase probing process is greater than the current throughput in step 723.

If the probing throughput according to the MCS level increase probing process is greater than the current throughput, the transmitting device changes a data rate to a probing data rate, and minimizes timer values of all timers in step 725. That is, the transmitting device increases an MCS level by 1 from a current MCS level, and minimizes the timer values of all of the timers.

If the probing throughput according to the bandwidth increase probing process is greater than the threshold throughput in step 715, the transmitting device proceeds to step 721. If the probing throughput according to the MCS level increase probing process is not greater than the probing throughput according to the bandwidth increase probing process, that is, the probing throughput according to the MCS level increase probing process is less than or equal to the probing throughput according to the bandwidth increase probing process in step 719, the transmitting device proceeds to step 721. The transmitting device determines whether the probing throughput according to the bandwidth increase probing process is greater than the current throughput in step 721.

If the probing throughput according to the bandwidth increase probing process is greater than the current throughput, the transmitting device changes a data rate to a probing data rate, and minimizes timer values of all of the timers in step 727. That is, the transmitting device increases a bandwidth to a bandwidth which is acquired by multiplying a current bandwidth by 2, and minimizes the timer values of all of the timers.

If the probing throughput according to the bandwidth increase probing process is not greater than the current throughput, that is, the probing throughput according to the bandwidth increase probing process is less than or equal to the current throughput in step 721, the transmitting device proceeds to step 729. If the probing throughput according to the MCS level increase probing process is not greater than the current throughput, that is, the probing throughput according to the MCS level increase probing process is less than or equal to the current throughput in step 723, the transmitting device proceeds to step 729.

The transmitting device determines to maintain the current data rate, and increases a timer value of each of the bandwidth increase timer and the MCS level increase timer in step 729. The transmitting device may determine the timer value of each of the bandwidth increase timer and the MCS level increase timer using Equation (13) and Equation (14), respectively, as follows.

a timer value of a bandwidth increase timer=Max(2×a timer value of a bandwidth increase timer, a maximum timer value)×Max(1, a probing packet loss rate/0.1) Equation (13)

a timer value of an MCS level increase timer=Max(2×a timer value of an MCS level increase timer, a maximum timer value)×Max(1, a probing packet loss rate/0.1) Equation (14)

As described in FIGS. 7A and 7B, if the bandwidth increase timer and the MCS level increase timer expire at the same time, the transmitting device determines a data rate corresponding to maximum throughput among the probing throughput according to the bandwidth increase probing process, the probing throughput according to the MCS level increase probing process, and the current throughput. That is, if the probing throughput according to the bandwidth increase probing process is the maximum throughput, the transmitting device changes a data rate to a data rate which corresponds to the bandwidth increase probing process, if the probing throughput according to the MCS level increase probing process is the maximum throughput, the transmitting device changes a data rate to a data rate which corresponds to the MCS level increase probing process, and if the current throughput is the maximum throughput, the transmitting device maintains the current data rate.

Although FIGS. 7A and 7B illustrates a method of performing a probing process corresponding to a bandwidth increase timer and an MCS level increase timer in a wireless communication system according to an embodiment of the present disclosure, various changes could be made to FIGS. 7A and 7B. For example, although shown as a series of steps, various steps in FIGS. 7A and 7B could overlap, occur in parallel, occur in a different order, or occur multiple times.

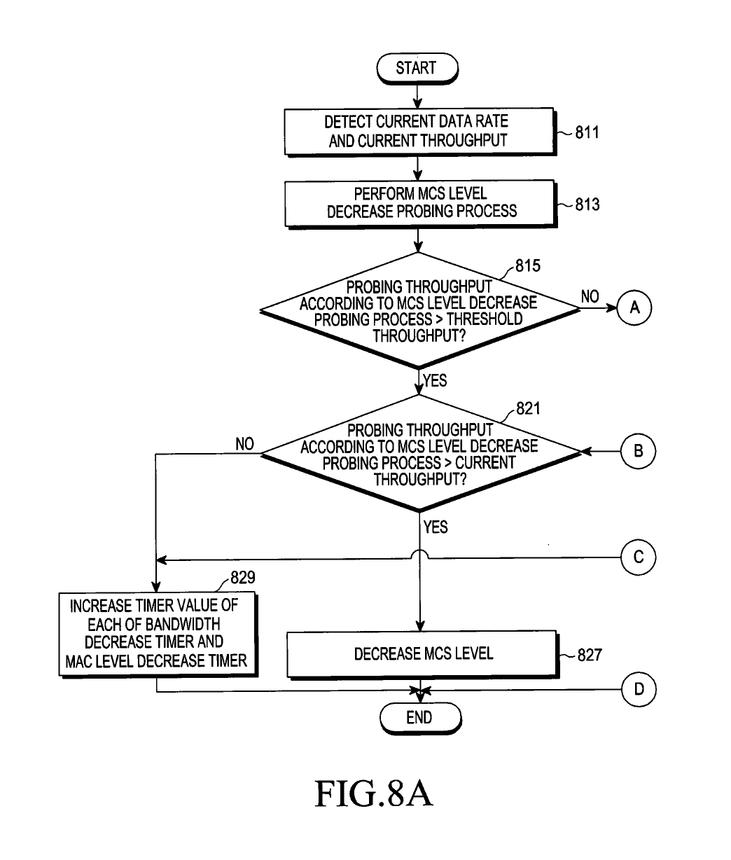

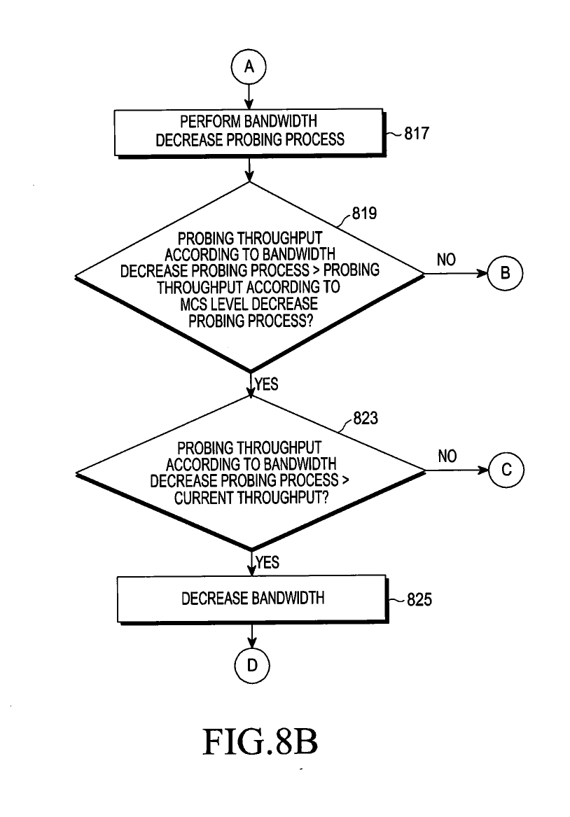

A method of performing a probing process corresponding to a bandwidth increase timer and an MCS level increase timer in a wireless communication system according to an embodiment of the present disclosure is described above with reference to FIGS. 7A and 7B, and a method of performing a probing process corresponding to a bandwidth decrease timer and an MCS level decrease timer in a wireless communication system according to an embodiment of the present disclosure is described below with reference to FIGS. 8A and 8B.

FIGS. 8A and 8B are flowcharts of a method of performing a probing process corresponding to a bandwidth decrease timer and an MCS level decrease timer in a wireless communication system according to an embodiment of the present disclosure.

Referring to FIGS. 8A and 8B, it will be noted that a method of performing a probing process corresponding to a bandwidth decrease timer and an MCS level decrease timer in FIGS. 8A and 8B is a method of performing a probing process in a case where a bandwidth decrease timer and an MCS level decrease timer expire at the same time.

A transmitting device detects a current data rate and a current throughput in step 811. The transmitting device performs an MCS level decrease probing process in step 813. The MCS level decrease probing process denotes a probing process of changing a data rate to a data rate which is acquired by decreasing a current MCS level by a preset number, e.g., 1, setting the changed data rate as a probing data rate, and transmitting data packets at the probing data rate during a time window.

The transmitting device determines whether probing throughput according to the MCS level decrease probing process is greater than preset threshold throughput in step 815. The reason why the transmitting device determines whether the probing throughput according to the MCS level decrease probing process is greater than the threshold throughput is that there is no need to perform a bandwidth decrease probing process since the probing throughput according to the MCS level decrease probing process is greater than a maximum value of the probing throughput according to the bandwidth decrease probing process if the probing throughput according to the MCS level decrease probing process is greater than the threshold throughput. The maximum value of the probing throughput according to the bandwidth decrease probing process denotes probing throughput according to the bandwidth decrease probing process in a case that a packet loss rate is 0, that is, a packet error does not occur.

If the probing throughput according to the MCS level decrease probing process is not greater than the threshold throughput, that is, the probing throughput according to the MCS level decrease probing process is less than or equal to the threshold throughput, the transmitting device performs a bandwidth decrease probing process in step 817. The bandwidth decrease probing process denotes a probing process of changing a data rate to a data rate which is acquired by decreasing a bandwidth from a current bandwidth to a bandwidth which is acquired by multiplying the current bandwidth by a preset number, e.g., 1/2, setting the changed data rate as a probing data rate, and transmitting data packets at the probing data rate during a time window.

The transmitting device determines whether the probing throughput according to the bandwidth decrease probing process is greater than the probing throughput according to the MCS level decrease probing process in step 819. If the probing throughput according to the bandwidth decrease probing process is greater than the probing throughput according to the MCS level decrease probing process, the transmitting device determines whether the probing throughput according to the bandwidth decrease probing process is greater than current throughput in step 823.

If the probing throughput according to the bandwidth decrease probing process is greater than current throughput, the transmitting device changes a data rate to a probing data rate, and minimizes timer values of all timers in step 825. That is, the transmitting device changes a bandwidth to a bandwidth which is acquired by multiplying a current bandwidth by 1/2, and minimizes the timer values of all timers.

If probing throughput according to the MCS level decrease probing process is greater than preset threshold throughput in step 815, the transmitting device proceeds to step 821. If the probing throughput according to the bandwidth decrease probing process is not greater than the probing throughput according to the MCS level decrease probing process, that is, the probing throughput according to the bandwidth decrease probing process is less than or equal to the probing throughput according to the MCS level decrease probing process in step 819, the transmitting device proceeds to step 821.

The transmitting device determines whether the probing throughput according to the MCS level decrease probing process is greater than the current throughput in step 821. If the probing throughput according to the MCS level decrease probing process is greater than the current throughput, the transmitting device proceeds to step 827.

The transmitting device changes a data rate to a probing data rate, and minimizes timer values of all of the timers in step 827. That is, the transmitting device decreases an MCS level by 1 from a current MCS level, and minimizes the timer values of all timers.

If the probing throughput according to the MCS level decrease probing process is not greater than the current throughput, that is, the probing throughput according to the MCS level decrease probing process is less than or equal to the current throughput in step 821, the transmitting device proceeds to step 829. If the probing throughput according to the bandwidth decrease probing process is not greater than the current throughput, that is, the probing throughput according to the bandwidth decrease probing process is less than or equal to the current throughput, the transmitting device proceeds to step 829.

The transmitting device determines to maintain the current data rate, and increases a timer value of each of the bandwidth decrease timer and the MCS level decrease timer in step 829. The transmitting device may determine the timer value of each of the bandwidth decrease timer and the MCS level decrease timer using Equation (15) and Equation (16), respectively, as follows.

a timer value of a bandwidth decrease timer=Max(2×a timer value of a bandwidth decrease timer, a maximum timer value)×Max(1, a probing packet loss rate/0.1) Equation (15)

a timer value of an MCS level decrease timer=Max(2×a timer value of an MCS level decrease timer, a maximum timer value)×Max(1, a probing packet loss rate/0.1) Equation (16)

As described in FIGS. 8A and 8B, if the bandwidth decrease timer and the MCS level decrease timer expire at the same time, the transmitting device determines a data rate corresponding to maximum throughput among the probing throughput according to the bandwidth decrease probing process, the probing throughput according to the MCS level decrease probing process, and the current throughput. That is, if the probing throughput according to the bandwidth decrease probing process is the maximum throughput, the transmitting device changes a data rate to a data rate which corresponds to the bandwidth decrease probing process, if the probing throughput according to the MCS level decrease probing process is the maximum throughput, the transmitting device changes a data rate to a data rate which corresponds to the MCS level decrease probing process, and if the current throughput is the maximum throughput, the transmitting device maintains the current data rate.

Although FIGS. 8A and 8B illustrate a method of performing a probing process corresponding to a bandwidth decrease timer and an MCS level decrease timer in a wireless communication system according to an embodiment of the present disclosure, various changes could be made to FIGS. 8A and 8B. For example, although shown as a series of steps, various steps in FIGS. 8A and 8B could overlap, occur in parallel, occur in a different order, or occur multiple times.

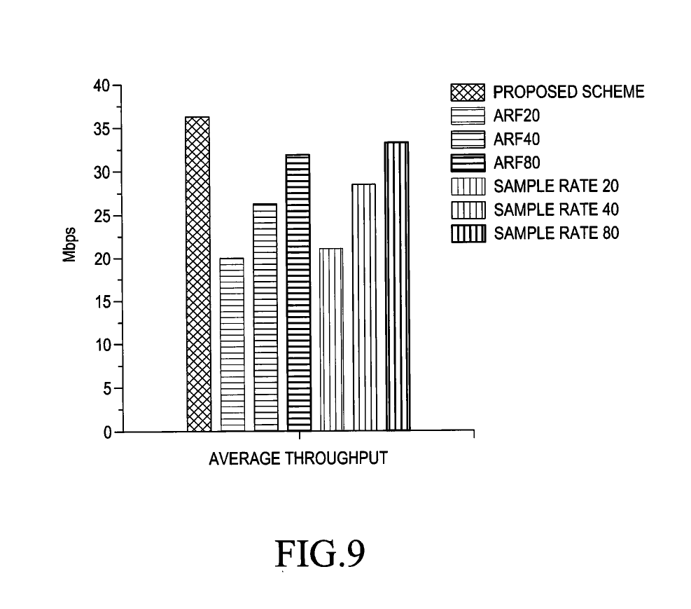

A method of performing a probing process corresponding to a bandwidth decrease timer and an MCS level decrease timer in a wireless communication system according to an embodiment of the present disclosure is described above with reference to FIGS. 8A and 8B, and performance according to data rate control in a non-interference environment in a wireless communication system according to an embodiment of the present disclosure is described below with reference to FIG. 9.

FIG. 9 is a graph illustrating performance according to data rate control in a non-interference environment in a wireless communication system according to an embodiment of the present disclosure.

Referring to FIG. 9, the graph shown in FIG. 9 is a graph indicating performance according to data rate control in a non-interference environment. More particularly, the graph shown in FIG. 9 is a graph indicating performance according to data rate control in a non-interference environment assuming the following simulation environment.

Simulation Environment

channel environment: IEEE 802.11 wireless LAN environment

total channel bandwidth: 80 MHz

bandwidth option: 20, 40, 80 MHz

Further, the non-interference environment denotes an environment where there is no interference signal, and the IEEE 802.11 wireless LAN environment may be an IEEE 802.11 ac wireless LAN environment.

In FIG. 9, a graph identified as “PROPOSED SCHEME” is a performance graph according to a data rate control scheme which is based on a bandwidth and an MCS according to an embodiment of the present disclosure.

In FIG. 9, graphs identified as ARF20, ARF40, and ARF80 are performance graphs according to a bandwidth option in a case where an ARF scheme is used. The graphs identified as ARF20, ARF40, and ARF80 are performance graphs in a case where a fixed bandwidth is used. For example, a graph as indicated by ARF40 is a performance graph in a case where a fixed bandwidth of 40 MHz is used and an MCS level is changed according to the ARF scheme.

In FIG. 9, graphs indicated by Sample Rate 20, Sample Rate 40, and Sample Rate 80 are performance graphs according to a bandwidth option in a case where a sample rate scheme is used. The graphs identified as Sample Rate 20, Sample Rate 40, and Sample Rate 80 are performance graphs in a case where a fixed bandwidth is used.

As shown in FIG. 9, it will be understood that performance according to a data rate control scheme which is based on a bandwidth and an MCS according to an embodiment of the present disclosure is better than performance according to an ARF scheme and performance according to a sample rate scheme.

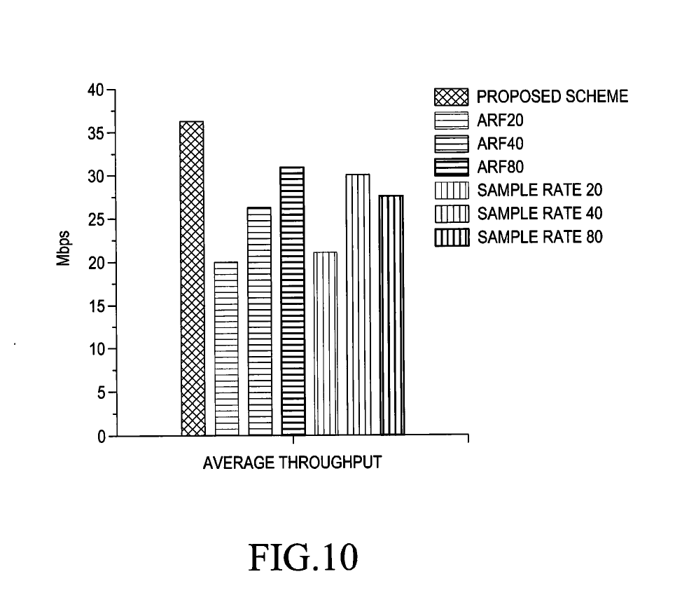

Performance according to data rate control in a non-interference environment in a wireless communication system according to an embodiment of the present disclosure is described above with reference to FIG. 9, and performance according to data rate control in an interference environment in a wireless communication system according to an embodiment of the present disclosure is described below with reference to FIG. 10.

FIG. 10 is a graph illustrating performance according to data rate control in an interference environment in a wireless communication system according to an embodiment of the present disclosure.

Referring to FIG. 10, the graph shown in FIG. 10 is a graph indicating performance according to data rate control in an interference environment. More particularly, the graph shown in FIG. 10 is a graph indicating performance according to data rate control in an interference environment assuming the following simulation environment.

Simulation Environment

channel environment: IEEE 802.11 wireless LAN environment

total channel bandwidth: 80 MHz

bandwidth option: 20, 40, 80 MHz

Further, the interference environment denotes an environment where there is an interference signal, e.g., an environment where there is an interference signal at 40 MHz among a total channel band of 80 MHz, and the IEEE 802.11 wireless LAN environment may be an IEEE 802.11 ac wireless LAN environment.

In FIG. 10, a graph identified as “PROPOSED SCHEME” is a performance graph according to a data rate control scheme which is based on a bandwidth and an MCS according to an embodiment of the present disclosure.

In FIG. 10, graphs identified as ARF20, ARF40, and ARF80 are performance graphs according to a bandwidth option in a case where an ARF scheme is used. The graphs identified as ARF20, ARF40, and ARF80 are performance graphs in a case where a fixed bandwidth is used. For example, a graph indicated by ARF40 is a performance graph in a case where a fixed bandwidth of 40 MHz is used and an MCS level is changed according to the ARF scheme.

In FIG. 10, graphs identified as Sample Rate 20, Sample Rate 40, and Sample Rate 80 are performance graphs according to a bandwidth option in a case where a sample rate scheme is used. The graphs identified as Sample Rate 20, Sample Rate 40, and Sample Rate 80 are performance graphs in a case where a fixed bandwidth is used.

As shown in FIG. 10, it will be understood that performance according to a data rate control scheme which is based on a bandwidth and an MCS according to an embodiment of the present disclosure is better than performance according to an ARF scheme and performance according to a sample rate scheme.

More particularly, it will be understood that performance according to a data rate control scheme which is based on a bandwidth and an MCS according to an embodiment of the present disclosure in FIG. 10 is better than performance according to a data rate control scheme which is based on a bandwidth and an MCS according to an embodiment of the present disclosure in FIG. 9. This is why a data rate control scheme which is based on a bandwidth and an MCS according to an embodiment of the present disclosure may effectively avoid a certain band where interference is strong.

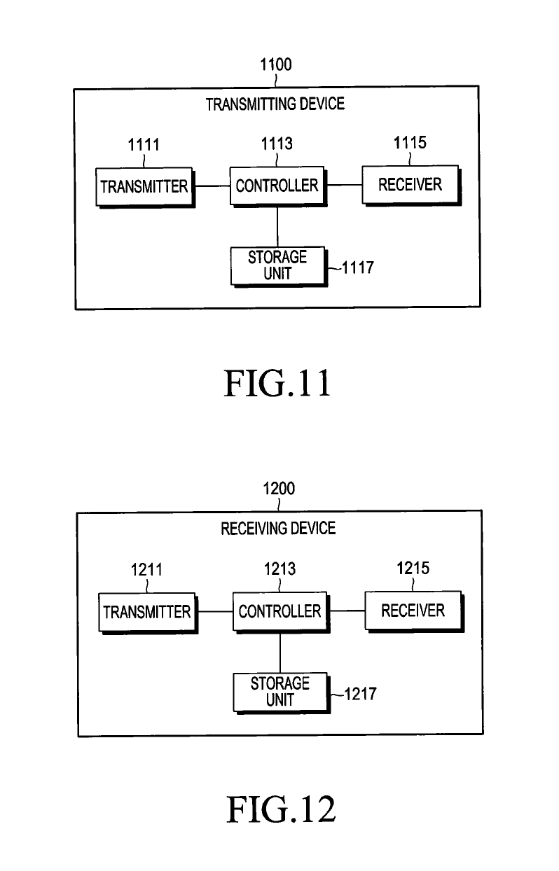

Performance according to data rate control in an interference environment in a wireless communication system according to an embodiment of the present disclosure is described above with reference to FIG. 10, and a transmitting device in a wireless communication system according to an embodiment of the present disclosure is described below with reference to FIG. 11.

FIG. 11 is a block diagram of a transmitting device 1100 in a wireless communication system according to an embodiment of the present disclosure. Referring to FIG. 11, the transmitting device 1100 includes a transmitter 1111, a controller 1113, a receiver 1115, and a storage unit 1117.

The controller 1113 controls the overall operation of the transmitting device 1100. More particularly, the controller 1113 controls the transmitting device 1100 to perform an operation related to controlling a data rate based on an MCS and a bandwidth. The operation related to controlling the data rate based on the MCS and the bandwidth is performed in the manner described above with reference to FIGS. 1 to 10, and a description thereof will be omitted herein.

The transmitter 1111 transmits various signals, various messages, and the like to other entities included in the wireless communication system, e.g., a receiving device, and the like under a control of the controller 1113. The various signals, the various messages, and the like transmitted in the transmitter 1111 are described above with reference to FIGS. 1 to 10, and a description thereof will be omitted herein.

The receiver 1115 receives various signals, various messages, and the like from other entities included in the wireless communication system, e.g., a receiving device, and the like under a control of the controller 1113. The various signals, the various messages and the like received in the receiver 1115 are described above with reference to FIGS. 1 to 10, and a description thereof will be omitted herein.

The storage unit 1117 stores a program and various data related to controlling the data rate based on the MCS and the bandwidth under a control of the controller 1113.

The storage unit 1117 stores the various signals, the various messages, and the like received in the receiver 1115.

While the transmitter 1111, the controller 1113, the receiver 1115, and the storage unit 1117 are described as separate units, it is to be understood that this is merely for convenience of description. In other words, two or more of the transmitter 1111, the controller 1113, the receiver 1115, and the storage unit 1117 may be incorporated into a single unit. Further, the transmitting device 1100 may be implemented as one processor.

A transmitting device 1100 in a wireless communication system according to an embodiment of the present disclosure is described above with reference to FIG. 11, and a receiving device 1200 in a wireless communication system according to an embodiment of the present disclosure is described below with reference to FIG. 12.

FIG. 12 is a block diagram of the receiving device 1200 in a wireless communication system according to an embodiment of the present disclosure.

Referring to FIG. 12, a receiving device 1200 includes a transmitter 1211, a controller 1213, a receiver 1215, and a storage unit 1217.

The controller 1213 controls the overall operation of the receiving device 1200. More particularly, the controller 1213 controls the receiving device 1200 to perform an operation related to controlling a data rate based on an MCS and a bandwidth. The operation related to controlling the data rate based on the MCS and the bandwidth is performed in the manner described above with reference to FIGS. 1 to 10, and a description thereof will be omitted herein.

The transmitter 1211 transmits various signals, various messages, and the like to other entities included in the wireless communication system, e.g., a transmitting device, and the like under a control of the controller 1213. The various signals, the various messages, and the like transmitted in the transmitter 1211 are described above with reference to FIGS. 1 to 10, and a description thereof will be omitted herein.

The receiver 1215 receives various signals, various messages, and the like from other entities included in the wireless communication system, e.g., a transmitting device, and the like under a control of the controller 1213. The various signals, the various messages and the like received in the receiver 1215 are described above with reference to FIGS. 1 to 10, and a description thereof will be omitted herein.

The storage unit 1217 stores a program and various data related to the operation of controlling the data rate based on the MCS and the bandwidth under a control of the controller 1213.

The storage unit 1217 stores the various signals, the various messages, and the like received in the receiver 1215.

While the transmitter 1211, the controller 1213, the receiver 1215, and the storage unit 1217 are described as separate units, it is to be understood that this is merely for convenience of description. In other words, two or more of the transmitter 1211, the controller 1213, the receiver 1215, and the storage unit 1217 may be incorporated into a single unit. Further, the receiving device 1200 may be implemented as one processor.

As is apparent from the foregoing description, an embodiment of the present disclosure enables control of a data rate based on a bandwidth and an MCS in a wireless communication system.

An embodiment of the present disclosure enables control of a data rate in an open-loop form in a wireless communication system.

An embodiment of the present disclosure enables control of a data rate based on a bandwidth and an MCS on a data packet basis in a wireless communication system.

An embodiment of the present disclosure enables control of a data rate thereby increasing communication throughput in a wireless communication system.

An embodiment of the present disclosure enables adaptive control of a data rate based on channel status in a wireless communication system.

An embodiment of the present disclosure enables control of a data rate thereby preventing interference in a wireless communication system.

Certain aspects of the present disclosure may also be embodied as computer readable code on a non-transitory computer readable recording medium. A non-transitory computer readable recording medium is any data storage device that can store data, which can be thereafter read by a computer system. Examples of a non-transitory computer readable recording medium include Read Only Memory (ROM), Random Access Memory (RAM), Compact Disk ROMs (CD-ROMs), magnetic tape, floppy disks, optical data storage devices, and carrier waves (such as data transmission through the Internet). The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

It can be appreciated that a method and apparatus according to an embodiment of the present disclosure may be implemented by hardware, software and/or a combination thereof. The software may be stored in non-volatile storage, for example, an erasable or re-writable ROM, a memory, for example, a RAM, a memory chip, a memory device, or a memory Integrated Circuit (IC), or an optically or magnetically recordable non-transitory machine-readable (e.g., computer-readable), storage medium (e.g., a CD, a Digital Versatile Disk (DVD), a magnetic disk, a magnetic tape, and/or the like). A method and apparatus according to an embodiment of the present disclosure may be implemented by a computer or a mobile terminal that includes a controller and a memory, and the memory may be an example of a non-transitory machine-readable (e.g., computer-readable) storage medium suitable to store a program or programs including instructions for implementing various embodiments of the present disclosure.

The present disclosure may include a program including code for implementing the apparatus and method as defined by the appended claims, and a non-transitory machine-readable (e.g., computer-readable), storage medium storing the program. The program may be electronically transferred via any media, such as communication signals, which are transmitted through wired and/or wireless connections, and the present disclosure may include their equivalents.

An apparatus according to an embodiment of the present disclosure may receive a program from a program providing device which is connected to the apparatus via a wired or a wireless connection and store the program. The program providing device may include a memory for storing instructions which for performing a content protection method which has already been installed, information necessary for the content protection method, and the like, a communication unit for performing a wired or a wireless communication with a graphics processing device, and a controller for transmitting a related program to a transmitting/receiving device based on a request of the graphics processing device or automatically transmitting the related program to the transmitting/receiving device.

While the present disclosure has been shown and described with reference to various embodiments thereof, it will be understood by those skilled in the art that various changes in form and details may be made therein without departing from the scope and spirit of the present disclosure as defined by the appended claims and their equivalents.

What is claimed is:

1. A method of controlling a data rate by a transmitting device in a wireless communication system, the method comprising:
detecting a condition to change a current data rate;
performing a probing process based on a bandwidth and a Modulation and Coding Scheme (MCS); and
controlling the data rate based on a result of the probing process.

2. The method of claim 1, wherein detecting the condition to change the current data rate comprises detecting the condition to change the current data rate if a bandwidth increase timer expires, and
wherein the bandwidth increase timer is set to a timer value which corresponds to a period by which a bandwidth increase probing process is performed at a date rate which is acquired by increasing the bandwidth by multiplying a current bandwidth by a preset number.

3. The method of claim 2, wherein performing the probing process based on the bandwidth and the MCS comprises:
performing a bandwidth increase probing process if a current packet loss rate is less than a preset threshold packet loss rate; and
performing a bandwidth increase/MCS level decrease probing process if a preset number of continuous packets are lost after performing the bandwidth increase probing process.

4. The method of claim 2, wherein performing the probing process based on the bandwidth and the MCS comprises increasing a timer value of the bandwidth increase timer if a current packet loss rate is greater than or equal to a preset threshold packet loss rate.

5. The method of claim 1, wherein detecting the condition to change the current data rate comprises detecting the condition to change the current data rate if a bandwidth decrease timer expires, and
wherein the bandwidth decrease timer is set to a timer value which corresponds to a period by which a bandwidth decrease probing process is performed at a date rate which is acquired by decreasing the bandwidth by multiplying a current bandwidth by a preset number.

6. The method of claim 5, wherein performing the probing process based on the bandwidth and the MCS comprises performing the bandwidth decrease probing process if a current packet loss rate is greater than a preset threshold packet loss rate.

7. The method of claim 1, wherein detecting the condition to change the current data rate comprises detecting the condition to change the current data rate if an MCS level increase timer expires, and
wherein the MCS level increase timer is set to a timer value which corresponds to a period by which an MCS level increase probing process is performed at the date rate which is acquired by increasing an MCS level by a preset number from a current MCS level.

8. The method of claim 1, wherein detecting the condition to change the current data rate comprises detecting the condition to change the current data rate if an MCS level decrease timer expires, and
wherein the MCS level decrease timer is set to a timer value which corresponds to a period by which an MCS level decrease probing process is performed at a date rate which is acquired by decreasing an MCS level by a preset number from a current MCS level.

9. The method of claim 1, wherein detecting the condition to change the current data rate comprises detecting the condition to change the current data rate if a bandwidth increase timer and an MCS level increase timer expire at the same time,
wherein the bandwidth increase timer is set to a timer value which corresponds to a period by which a bandwidth increase probing process is performed at the date rate which is acquired by increasing the bandwidth by multiplying a current bandwidth by a preset number, and
wherein the MCS level increase timer is set to a timer value which corresponds to a period by which an MCS level increase probing process is performed at the date rate which is acquired by increasing an MCS level by a preset number from a current MCS level.

10. The method of claim 1, wherein detecting the condition to change the current data rate comprises detecting the condition to change the current data rate if a bandwidth decrease timer and an MCS level decrease timer expire simultaneously,
wherein the bandwidth decrease timer is set to a timer value which corresponds to a period by which a bandwidth decrease probing process is performed at a date rate which is acquired by decreasing the bandwidth by multiplying a current bandwidth by a preset number, and
wherein the MCS level decrease timer is set to a timer value which corresponds to a period by which an MCS level decrease probing process is performed at a date rate which is acquired by decreasing an MCS level by a preset number from a current MCS level.

11. A transmitting device in a wireless communication system, the transmitting device comprising:
a controller configured to detect a condition to change a current data rate; and
a transmitter and a receiver configured to perform a probing process based on a bandwidth and a Modulation and Coding Scheme (MCS),
wherein the controller is further configured to control a data rate based on a result of the probing process.

12. The transmitting device of claim 11, wherein the controller is further configured to detect the condition to change the current data rate if a bandwidth increase timer expires,
wherein the bandwidth increase timer is set to a timer value which corresponds to a period by which a bandwidth increase probing process is performed at a date rate which is acquired by increasing a bandwidth by multiplying a current bandwidth by a preset number.

13. The transmitting device of claim 12, wherein the transmitter and the receiver are further configured to perform a bandwidth increase probing process if a current packet loss rate is less than a preset threshold packet loss rate; and
perform a bandwidth increase/MCS level decrease probing process if a preset number of continuous packets are lost after performing the bandwidth increase probing process.

14. The transmitting device of claim 11, wherein the transmitter and the receiver are further configured to increase a timer value of the bandwidth increase timer if a current packet loss rate is greater than or equal to a preset threshold packet loss rate.

15. The transmitting device of claim 11, wherein the controller is further configured to detect the condition to change the current data rate if a bandwidth decrease timer expires,
wherein the bandwidth decrease timer is set to a timer value which corresponds to a period by which a bandwidth decrease probing process is performed at a date rate which is acquired by decreasing the bandwidth by multiplying a current bandwidth by a preset number.

16. The transmitting device of claim 15, wherein the transmitter and the receiver are further configured to perform a bandwidth decrease probing process if a current packet loss rate is greater than a preset threshold packet loss rate.

17. The transmitting device of claim 11, wherein the controller is further configured to detect the condition to change the current data rate if an MCS level increase timer expires,
wherein the MCS level increase timer is set to a timer value which corresponds to a period by which an MCS level increase probing process is performed at a date rate which is acquired by increasing an MCS level by a preset number from a current MCS level.

18. The transmitting device of claim 11, wherein the controller is further configured to detect the condition to change the current data rate if an MCS level decrease timer expires,
wherein the MCS level decrease timer is set to a timer value which corresponds to a period by which an MCS level decrease probing process is performed at a date rate which is acquired by decreasing an MCS level by a preset number from a current MCS level.

19. The transmitting device of claim 11, wherein the controller is further configured to detect the condition to change the current data rate if a bandwidth increase timer and an MCS level increase timer expire simultaneously,
wherein the bandwidth increase timer is set to a timer value which corresponds to a period by which a bandwidth increase probing process is performed at a date rate which is acquired by increasing the bandwidth by multiplying a current bandwidth by a preset number,
wherein the MCS level increase timer is set to a timer value which corresponds to a period by which an MCS level increase probing process is performed at a date rate which is acquired by increasing an MCS level by a preset number from a current MCS level.

20. The transmitting device of claim 11, wherein the controller is further configured to detect the condition to change the current data rate if a bandwidth decrease timer and an MCS level decrease timer expire simultaneously,
wherein the bandwidth decrease timer is set to a timer value which corresponds to a period by which a bandwidth decrease probing process is performed at a date rate which is acquired by decreasing the bandwidth by multiplying a current bandwidth by a preset number, and
wherein the MCS level decrease timer is set to a timer value which corresponds to a period by which an MCS level decrease probing process is performed at a date rate which is acquired by decreasing an MCS level by a preset number from a current MCS level.
